(19) United States
(12) Patent Application Publication
(10) Pub. No.: US 2007/0034270 A1
(43) Pub. Date: Feb. 15, 2007

(54) MICROFLUIDIC SEPARATING AND TRANSPORTING DEVICE

(76) Inventors: Jing-Tang Yang, Hsinchu (TW); Chien-Yang Chen, Hsinchu County (TW); Tzung-Han Yang, Taichung County (TW); Tsung-Yu Chen, Taichung County (TW)

Correspondence Address: SINORICA, LLC, 528 FALLSGROVE DRIVE, ROCKVILLE, MD, 20850, US

(21) Appl. No.: 11/462,002

(22) Filed: Aug. 2, 2006

(30) Foreign Application Priority Data
Aug. 9, 2005 (TW) 94126927

(51) Int. Cl. F15C 1/06

(52) U.S. Cl. 137/833

(57) ABSTRACT

The present invention discloses a microfluidic separating and transporting device, which utilizes free-energy gradient surfaces having micro/nano physical and chemical properties to drive and separate microfluids automatically. The device of the present invention comprises a platform having microchannels. The surfaces of the microchannels have surface energy gradient-inducing rare-to-dense microstructures. The rare-to-dense microstructures are formed in two regions; one is formed in the primary microchannel and used to transport microfluids, and the other is formed in the microfluid bifurcation region. When different microfluids flow through the microfluid bifurcation region, the microfluids will separate automatically to their own secondary microchannels according to the surface energy gradient. Thereby, droplets of different microfluids can be separated apart or split into diffluences.

### BACKGROUND OF THE INVENTION

1. Field of the Invention

The present relates to a microfluidic separating and transporting device, particularly to a microfluidic separating and transporting device, wherein the surface energy gradient of microfluids, which is induced by a micro/nano structure fabricated with a microelectromechanical technology, is used to separate microfluidic droplets.

2. Description of the Related Art

When a biochemical analysis is undertaken in a microfluidic chip, a series of different droplets is transported, separated and mixed in microchannels. The key technology of microfluidic systems is the control technology of microfluids. As the dimension of microfluidic systems has been reduced to micrometer scale, surface tension outweighs gravity and becomes the major driving force of microfluidic systems. Surface tension is in a linear relationship with length, i.e. F=γ×λ. Therefore, the smaller the system, the greater the influence of surface tension. The common energy types used to affect surface tension and control microfluidic systems include: thermal energy (via thermocapillary effect) and electric energy (via electrowetting effect), which respectively utilize thermal energy and electric energy to locally change the surface tension of microfluids and then control the movement of microfluids. However, those externally applied energies may have influence on microfluids. Thus, the application of microfluidic systems may be limited. For example, when a biomedical test is undertaken, externally applied thermal energy may raise the temperature of tested solutions, and an externally applied electric field may polarize the substances distributed inside microfluids; thus, the characteristics of solutions and biological molecules may be changed, and the correction of test results may be affected.

Refer to FIG. 1 for a conventional microfluidic separating and transporting device proposed by a U.S. Pat. No. 6,878,555B2. As shown in FIG. 1, the droplet injection and separation system 100 has a rotary disc 103, and multiple microchannels 102 radiate outward from the center of the surface 112 of the rotary disc 103. The droplet inlets 101 of the microchannels 102 are designated by I, and I=1˜6. The surface 112 of the rotary disc 103 is vertical to an axle 117, and the axle 117 passes through the center of the rotary disc 103 and drives the rotary disc 103 to rotate. The surface 112 of the rotary disc 103 has special optical marks 104. The system 100 has an optical detector 105 and a signal controller 114. When the special optical mark 104 passes through the optical detector 105, the optical detector 105 produces a signal to the signal controller 114, and the signals controller 114 triggers a valve 107 of a droplet injector 110 so that a droplet 111 generated by the droplet injector 110 will drop onto the droplet inlet 101 of a specified microchannel 102. Then, the droplet 111 is guided to the terminal end of the specified microchannel 102, and the entire transporting process is thus completed.

The key point of the conventional technology mentioned above is: the optical mark on the rotary disc creates a signal; the signal controller receives the signal and controls the timing that the droplet injector generates a droplet and the speed of the rotary disc so that the droplet can drop onto the inlet of a specified microchannel; then, the centrifugal force transports the droplet to the reaction region at the terminal end of the microchannel for succeeding application or processing.

However, the conventional technology mentioned above needs high precision signal control and consumes more energy. Thus, the design of the elements thereof and the development of the fabrication process thereof are relatively complicated, and the cost thereof is also raised. Further, there are too many parameters needing considering and controlling, such as the delay time between signal receiving and droplet generation, the size and type of the droplet, the distance between the outlet of the droplet injector and the surface of the rotary disc, the time the droplet needs to reach the inlet of the microchannel, the rotation speed of the rotary disc, etc. All those parameters need precise calculation and control so that the droplet can precisely drop onto the inlet of the assigned microchannel. Too many control parameters cause difficulties in operating the system and maintaining the reliability of the system.

In a conventional technology proposed by a US patent US 20050045238A1, microstructures with different densities are used as valves in microchannels. When a microfluid reaches such a valve, the microfluid will stop automatically. Based on the principle of this conventional technology, the present invention proposes a microfluidic separating and transporting device, which utilizes surface energy gradient to separate microfluidic droplets. Thereby, the problems of the conventional technologies can be solved.

### SUMMARY OF THE INVENTION

The primary objective of the present invention is to provide a microfluidic separating and transporting device, wherein the surface energy gradient is used to influence the hydrophobias of the surfaces of microchannels and influence the contact phenomenon between the microfluids and the surfaces of microchannels so that the droplets of different microfluids can be driven to move, separated apart or split into diffluences.

Another objective of the present invention is to provide a microfluidic separating and transporting device, which can promote the microfluidic mixing efficiency of biological chips, increase test types of microfluids, simplify the transporting process of microfluids and reduce the fabrication cost of biological chips.

Further another objective of the present invention is to provide a microfluidic separating and transporting device, which can use less elements and parameters to achieve easy operation, high power efficiency, high biological compatibility, automation and simplified fabrication process, and may be contributive to the future integration of microfluidic transporting systems.

To achieve the abovementioned objectives, the present invention proposes a microfluidic separating and transporting device, which comprises a primary microchannel and at least one secondary microchannel. The droplets of microfluids may be dropped onto the primary microchannel and flow in the primary microchannel. At least one rare-to-dense microstrip pattern is formed in the primary microchannel or the bifurcation regions between the primary microchannel and the secondary microchannels. When droplets of different microfluids flow through the rare-to-dense microstrip pattern, the surface energy gradient will separate the droplets of different microfluids.

To enable the objectives, technical contents, characteristics and accomplishments of the present invention to be more easily understood, the embodiments of the present invention are to described in detail in cooperation with the attached drawings below.

### BRIEF DESCRIPTION OF THE DRAWINGS

FIG. 1 is a diagram schematically a conventional microfluidic droplet separating and transporting device.

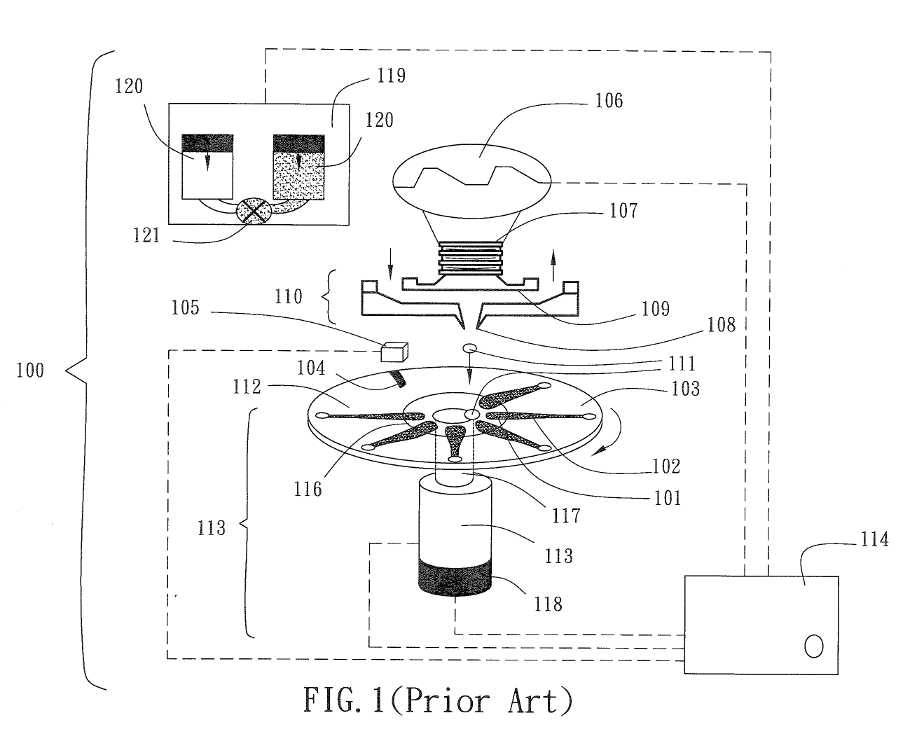

FIG. 2 is a diagram schematically showing the microfluidic separating and transporting device according to one embodiment of the present invention.

FIG. 3 is a diagram schematically showing the microfluidic separating and transporting device according to another embodiment of the present invention.

FIG. 4 is an SEM photograph of a rare-to-dense microstrip pattern according to the present invention.

### DETAILED DESCRIPTION OF THE INVENTION

The present invention utilizes a physical or chemical method to fabricate density-variation surface energy gradient microstructures, i.e. rare-to-dense microstrip patterns, which create different surface tension gradients between microfluids and the inner walls of the microchannels along the flowing direction of the microfluids to drive the microfluids to flow automatically. The microfluids flow to the bifurcation regions between the primary microchannel and the secondary microchannels spontaneously via the driving force of surface tension gradient. The bifurcation regions connect with the secondary microchannels having density-variation micro/nano structures, which enable the secondary microchannels to have different hydrophobias. Thus, when the microfluids flow to the bifurcation regions, they will respectively enter into the microchannels having their own hydrophobias. Thereby, the microfluids can be precisely and automatically separated and guided to the assigned secondary microchannels.

Below, the technical means and the accomplishments of the present invention are to be described in cooperation with the attached drawings. However, the embodiments illustrated by the drawings are only used to clarify the present invention complementarily, and the scope of the present invention is not limited by the drawings shown hereinafter.

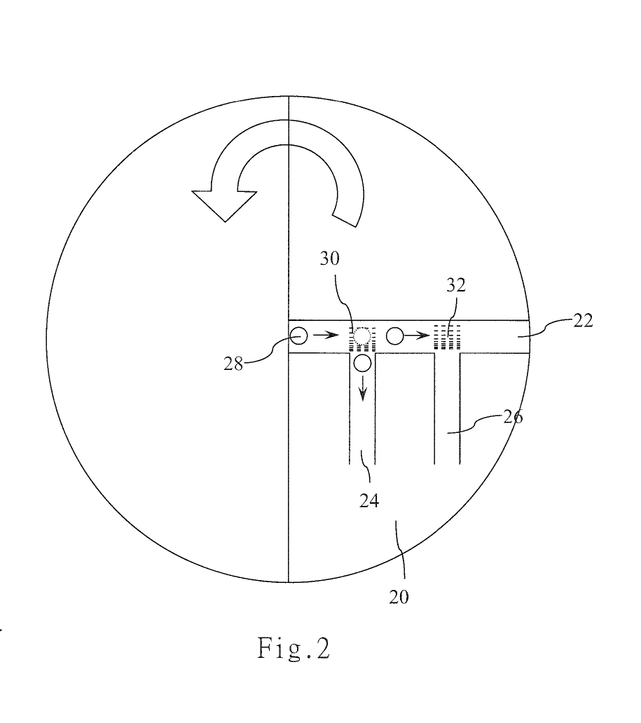

Refer to FIG. 2 a diagram schematically showing one embodiment of the present invention, wherein microchannels with special rare-to-dense microstrip patterns are fabricated on a rotary platform. As shown in FIG. 2, a rotary platform 20 has a primary microchannel 22; a first secondary microchannel 24 and a second secondary microchannel 26 extend from the primary microchannel 22. A microfluidic droplet 28 can be dropped onto the inlet of the primary microchannel 22. The bifurcation region between the primary microchannel 22 and the first secondary microchannel 24 has a first microstrip region 30 with the microstrips being rare-to-dense from top to bottom. The bifurcation region between the primary microchannel 22 and the second secondary microchannel 26 has a second microstrip region 32 with the microstrips also being rare-to-dense from top to bottom. Both the first microstrip region 30 and the second microstrip region 32 create downward forces, but the downward force in the second microstrip region 32 is stronger than that of the first microstrip region 30. When the centrifugal force of the spinning rotary platform 20 is smaller than the force in the first microstrip region 30, the microfluidic droplet 28 will enter into the first secondary microchannel 24. If the centrifugal force is raised, the microfluidic droplet 28 will not enter into the first secondary microchannel 24 but will continue to head forward and reach the second microstrip region 32. If the centrifugal force of the spinning rotary platform 20 is smaller than the force in the second microstrip region 32, the microfluidic droplet 28 will enter into the second secondary microchannel 26. If the centrifugal force of the spinning rotary platform 20 is greater than the force in the second microstrip region 32, the microfluidic droplet 28 will not enter into the second secondary microchannel 26 but will continue to head forward along the primary microchannel 22. Via the abovementioned mechanism, the microfluidic droplets with different inertia forces can be separated and then transported to the assigned reaction regions or collection regions (not shown in the drawing).

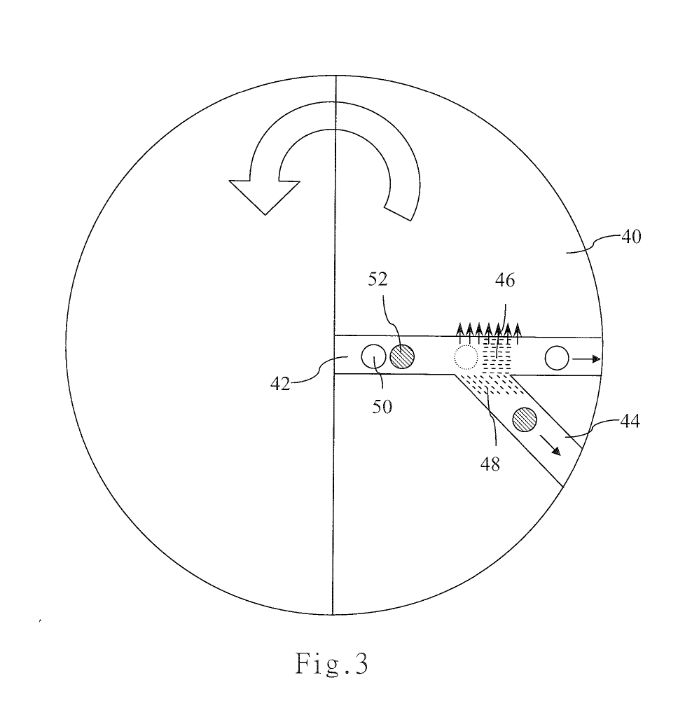

In addition to the abovementioned embodiment, the microfluidic droplets may also be separated under a fixed centrifugal force. Refer to FIG. 3 for another embodiment of the present invention. As shown in FIG. 3, a rotary platform 40 has a primary microchannel 42; a secondary microchannels 44 extends from the primary microchannel 42. The microfluidic droplets can be dropped onto the inlet of the primary microchannel 42. The bifurcation region between the primary microchannel 42 and the secondary microchannel 44 has an upper microstrip region 46 and a lower microstrip region 48, and the active force of the upper microstrip region 46 is stronger than that of the lower microstrip region 48. Under a fixed centrifugal force, there are two microfluidic droplets 50 and 52, and the surface energy of the microfluidic droplet 52 is greater than that of the microfluidic droplet 50. Under the action of the centrifugal force and the surface energy, the upper microstrip region 46 will drag the droplet 50 to head forward along the primary microchannel 42. The droplet 52 will be dragged to enter into the secondary microchannel 44 by the lower microstrip region 48. Thereby, the droplets of different surface energies can be separated.

In the abovementioned two embodiments, a spacer (not shown in the drawings) may be formed in the lateral sides of the primary microchannel and the secondary microchannels. The spacer is used to control the height of the microfluidic droplet, and the height of the spacer ranges from tens of micrometers to millimeters. An upper cover (not shown in the drawings) may be installed above the spacer. The upper cover is used to isolate the microfluidic droplets inside the primary microchannel and the secondary microchannels from the external environment. Besides, the surface of the upper cover may be smooth or have a special microstrip pattern.

Above, the technical contents of the present invention have been described in detail. Below, the physical principle of the present invention is to be stated so that the persons skilled in the art can further understand the spirit of the present invention. When a microfluidic droplet contacts two interfaces respectively having different hydrophobias, the contact angles and the radii of the curvatures of both ends of the microfluidic droplet are asymmetric because of the distribution of surface energy gradient. Thus, the pressure differences to the surrounding air at both ends of the microfluidic droplet are unequal. The unbalanced pressures will induce a net pressure difference inside the droplet, which is exactly the source of the driving force F_{act} for the droplet contacting two surfaces with different hydrophobias. The surface energy gradient may be implemented with patterns having microtrenches arranged in different densities. According to Laplace-Young equation, the driving force may be expressed by:

$$\begin{matrix}{F}_{act} = {γ}_{LV} \cdot {A}_{eff} \cdot \{ ( \frac{1}{{r}_{2}} - \frac{1}{{r}_{1}} ) \} & ( 1 ) \\ {A}_{eff} = \frac{2 {θ}_{o}}{360} \cdot π \cdot {( \frac{{w}_{o}}{2 sin {θ}_{o}} )}^{2} + \vert \frac{{w}_{o}^{2} cot {θ}_{o}}{4} \vert & ( 2 )\end{matrix}$$

wherein F_{act} is the driving force of the surface having heterogeneous microstructures to the droplet; γ_{LV} is the surface tension of the liquid-vapor phase interface; A_{eff} is the area of the droplet section orthogonal to the movement direction; r₁ and r₂ are the radii of the curvatures of both ends of the droplet; wₒ is the contact length between the droplet and the solid surface in the orthogonal direction; and θₒ is the contact angle between the droplet and the surface in the orthogonal direction.

The resistance force Fᵣₑₛ to the droplet movement induced by the surfaces with different hydrophobias can be expressed by
Fᵣₑₛ=γ_{LV}·f₁·wₒ·(cos θ_{R}−cos θ_{A}) (3)
wherein f₁ is the density of the microstructure distribution on the surface of the microchannel; cos θ_{A} and cos θ_{R} are respectively the cosine values of the advance angle and the recession angle of the droplet. When the resistance force Fᵣₑₛ is greater than the driving force F_{act}, the droplet sticks to the surface of the microchannel. When the resistance force Fᵣₑₛ is smaller than the driving force F_{act}, the droplet moves on the surface of the microchannel. From Equation (3), it is known that the resistance force Fᵣₑₛ can be changed via modifying the density f₁ of the microstructure (microstrip) distribution on the surface of the microchannel. In other word, modifying the parameter f₁ can precisely control the droplet to advance or stay.

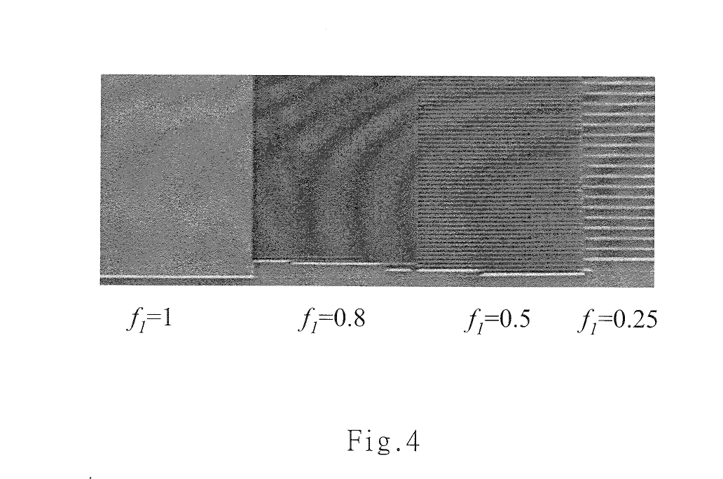

As shown in FIG. 4, according to the calculation results of the related theories and the experimental data, a rare-to-dense microstrip pattern is designed to prove the practicability of the present invention, wherein the densities of the microstructures increase from right to left, and the densities f₁ thereof are respectively 0.25, 0.5, 0.8 and 1; each region of microstrips is 5 micrometers wide, 1000 micrometers long and more than 10 micrometers high. When a droplet is placed in the interface between the right two regions, it will move leftward continuously until it reaches the leftmost region where f₁=1, and then, the droplet stops there. Via the hydrophobias gradient created by a heterogeneous microstructure design, the droplet tends to move toward the region of lower hydrophobias. Thereby, the direction of droplet movement can be controlled.

The present invention can apply to the flow path separation procedures and the output point assignment procedures in a series of digitized microchannel transporting processes of droplets and can achieve the objectives of easy operation, high power efficiency, high biological compatibility, automation and simplified fabrication process. Further, the present invention can promote the microfluidic mixing efficiency of biological chips, increase test types of microfluids, simplify the transporting process of microfluids and reduce the fabrication cost of biological chips. Therefore, it is obvious that the present invention can fully overcome the problems of the conventional technologies.

Those described above are only the embodiments to clarify the present invention to enable the persons skilled in the art to understand, make and use the present invention. However, it is not intended to limit the scope of the present invention, and any equivalent modification and variation according to the spirit of the present invention is to be also included within the scope of the present invention.

What is claimed is:

1. A microfluidic separating and transporting device, comprising:
a platform, having a primary microchannel and at least one secondary microchannel extending from said primary microchannel with droplets of microfluids able to drop onto said primary microchannel; and
at least one rare-to-dense microstrip pattern, formed on the surface of said platform, and creating a surface energy gradient to separate or spilt into diffluences said droplets flowing through said rare-to-dense microstrip pattern.

2. The microfluidic separating and transporting device according to claim 1, wherein said rare-to-dense microstrip pattern is formed on the surface of said primary microchannel and used to transport the separated microfluids.

3. The microfluidic separating and transporting device according to claim 1, wherein said rare-to-dense microstrip pattern is formed on the bifurcation region between said primary microchannel and said secondary microchannel and used to split said microfluids into diffluences.

4. The microfluidic separating and transporting device according to claim 1, wherein said rare-to-dense microstrip pattern is formed of microstrips, which induce continuously decreasing surface energy.

5. The microfluidic separating and transporting device according to claim 1, wherein the width, height and spacing of said rare-to-dense microstrip pattern range from nanometers to micrometers.

6. The microfluidic separating and transporting device according to claim 1, wherein said primary microchannel can separate said microfluidic droplets to different secondary microchannels.

7. The microfluidic separating and transporting device according to claim 1, wherein a spacer is formed on said platform and on the lateral sides of said primary microchannel and said secondary microchannel and used to control the height of said microfluidic droplet.

8. The microfluidic separating and transporting device according to claim 7, wherein the height of said spacer ranges from tens of micrometers to millimeters.

9. The microfluidic separating and transporting device according to claim 7, further comprising an upper cover, which is installed above said spacer and used to isolate said microfluidic droplets inside said primary microchannel and said secondary microchannel from the external environment.

10. The microfluidic separating and transporting device according to claim 9, wherein the surface of said upper cover is smooth or has a special pattern.

11. The microfluidic separating and transporting device according to claim 1, wherein external electrodes are added to said rare-to-dense microstrip pattern and used to enhance the driving force for said microfluidic droplets.

12. The microfluidic separating and transporting device according to claim 1, wherein an external magnetic field is used to enhance the driving force for said microfluidic droplet with magnetic grains.

13. The microfluidic separating and transporting device according to claim 1, wherein a focused light beam is used to illuminate the contact angle of said microfluidic droplet and enhance the driving force for said microfluidic droplet.

14. The microfluidic separating and transporting device according to claim 1, wherein a surface sonic wave is used to enhance the driving force for said microfluidic droplet.

15. The microfluidic separating and transporting device according to claim 1, wherein the driving force for said microfluidic droplet is a centrifugal force.

16. The microfluidic separating and transporting device according to claim 1, wherein the material of said rare-to-dense microstrip pattern may be a polymer, a ceramic or a metal.

17. The microfluidic separating and transporting device according to claim 1, wherein the angle contained between said primary microchannel and said secondary microchannel ranges from 0 to 90 degrees.

18. The microfluidic separating and transporting device according to claim 5, wherein the widths of said primary microchannel and said secondary microchannel range from micrometers to hundreds of micrometers.

19. A microfluidic separating and transporting device, comprising:
a surface, for the movement of microfluidic droplets; and
a special pattern, formed on said surface, and creating surface energy gradient to separate said microfluidic droplets.

20. The microfluidic separating and transporting device according to claim 19, wherein said special pattern is formed on a primary microchannel on said surface and used to transport the separated microfluids, or said special pattern is formed on the bifurcation region between said primary microchannel and a secondary microchannel and used to split said microfluidic droplets into diffluences.
